(19) United States
(12) Patent Application Publication
(10) Pub. No.: US 2003/0152127 A1
(43) Pub. Date: Aug. 14, 2003

(54) Integrated etalon-beam splitter

(75) Inventors: John C. Tsai, Saratoga, CA (US); David W. Wang, Saratoga, CA (US); George C.K. Chen, Santa Clara, CA (US); Joseph Methe, San Jose, CA (US)

Correspondence Address: INTELLECTUAL PROPERTY LAW OFFICE, 1901 S. BASCOM AVENUE, SUITE 660, CAMPBELL, CA, 95008, US

(73) Assignee: Fibera, Inc., Santa Clara, CA

(21) Appl. No.: 10/064,663

(22) Filed: Aug. 5, 2002

Related U.S. Application Data
(60) Provisional application No. 60/356,546, filed on Feb. 12, 2002.

(51) Int. Cl. H01S 3/08

(52) U.S. Cl. 372/98; 372/92

(57) ABSTRACT

An integrated or hybrid-optical device (10) able to perform the functions of both a beam splitter and an etalon. A splitter interface (72), front-cavity interface (74), and rear-cavity interface (76) are provided and separate regions (78, 80, 82, 84) which may be of “air” (gas or vacuum) or solid materials. The front-cavity interface (74), the rear-cavity interface (76), and the interposed third region (82) define a Fabry Perot etalon, which may be either solid or air-spaced. In particular, the integrated optical device (10) has only the second region (80) interposed between the splitter interface (72) and the front-cavity interface (74).

### CROSS REFERENCE TO RELATED APPLICATIONS

This application claims the benefit of U.S. Provisional Application No. 60/356,546, filed Feb. 12, 2002.

### BACKGROUND OF INVENTION

The present invention relates generally to methods and apparatus wherein an interference phenomenon is used to analyze the spectral characteristics of light, and more particularly to measuring and testing by using a Fabry-Perot interferometer or etalon having a specific structure or configuration. It is anticipated that one primary application of the present invention will be in optical telecommunications, particularly including wavelength division multiplexing. However, the present invention is also well suited to use in laboratory measurement and in other fields where methods and compact, robust, and precise apparatus for the determination or use of light spectral characteristics are desired.

Fabry-Perot (solid or “air” spaced) etalons and diffractive gratings are known to produce precision interference patterns for use in detection and measurement of small objects and for wavelength control in fiber optic communications. For example, they are currently used for frequency locker and interleaver applications.

The frequency locker (sometimes also called the “wavelength locker”) is becoming a critical component in fiber optic telecommunication applications. In such telecommunications a laser beam is employed to carry information. The function of the frequency locker here is to monitor the fluctuation of laser frequency and provide a correction signal to the laser controller. The laser controller is then able to maintain the frequency, typically near an International Telecommunication Union (ITU) specified frequency.

A common prior art frequency locker construction is shown in FIG. 1 (background art). A laser beam enters the frequency locker unit and encounters a first beam splitter, where it is split into two components. One beam component is used by the telecommunications system and is not generally of further concern here. The other beam component is a sample component that enters the frequency locker proper. The sample component encounters a second beam splitter and is further split into two components: a reference component and a measurement component. The reference component goes to a reference photodetector, which monitors the intensity of the laser beam. The other, measurement component enters interference optics, typically including either a Fabry-Perot (solid or air-spaced) etalon or a diffractive grating, and an interference pattern is produced. A measurement detector then detects the interference in the measurement component as it exits the interference optics and produces an interference signal. The amplitude of the interference signal is dependent on the value of the laser frequency. When the laser frequency matches with a specified frequency (based upon characteristics of the interference optics), the output of the reference photodetector will be equal to the measurement photodetector. Deviation from the specified frequency causes unbalance in the signals detected by the two photo detectors and an error signal is generated which may be employed for frequency correction.

Multi-channel frequency lockers have historically been constructed by combining single-channel frequency lockers like that in FIG. 1. Since discrete beam splitters and interference optics are used in these prior art approaches, however, the whole assembly occupies a rather large space. This is unfortunate because there are strong trends in the industry to reduce overall equipment form-factors and toward multi-channel capable equipment.

FIG. 2 (background art) depicts a recent improvement on this, wherein the beam splitter and interference optics handle multiple laser beams and component parts of them concurrently. This particular multi-channel frequency locker is the subject of U.S. patent application Ser. No. 10/039,276, filed Apr. 1, 2002 by some of the present inventors.

In view of the trends discussed above, the structure of the existing frequency locker has particular disadvantages. The occupied space is an obvious concern to the final assembly. Excessive optical components are needed in order to complete the assembly. Each optical component is individually fabricated, installed, and adjusted, and this increases the initial material and labor costs. Scrapage or rework are also high, due to the multiple opportunities for error in the complex manufacturing processes required.

An unduly high component count also exacerbates maintenance concerns. For example, problems may arise in a frequency locker because vibration, shock, thermal effects, etc. cause component movement. Many frequency locker applications today are used in harsh or even remote environments. This makes replacement difficult and highly undesirable. Furthermore, the construction of frequency lockers for such environments may make their repair essentially impossible.

In sum, in view of the needs of reduction in size and cost, and for improved reliability, the existing frequency locker configuration is no longer suitable for meeting present and future requirements. One key reason for this is the complexity of the discrete-component beam splitters and etalons used. Accordingly, what is needed is a less complex component configuration.

### SUMMARY OF INVENTION

Accordingly, it is an object of the present invention to provide an integrated-component type device that performs the roles of beam splitter and etalon.

Briefly, one preferred embodiment of the present invention is an optical device for splitting an incident beam of light into a reflected beam and a transmitted beam and selectively transmitting only a narrow bandwidth of that transmitted beam. A splitter interface is provided at the junction of a first region and a second region. This splitter interface is suitable for splitting the incident beam into the reflected beam and the transmitted beam. A front-cavity interface is provided at the junction of the second region and a third region. This front-cavity interface is suitable for receiving the transmitted beam from the splitter interface and directing it onward at a normal angle. A rear-cavity interface is provided at the junction of the third region and a fourth region. This rear-cavity interface is suitable for receiving the transmitted beam from the front-cavity interface at a normal angle. The front-cavity interface and the rear-cavity interface are fixedly spaced apart by the third region and are partially reflective to the transmitted beam. This defines an optical cavity in the manner of a Fabry-Perot interferometer. In sum, both integrated beam splitting and etalon functionality is thereby provided in the device.

Briefly, another preferred embodiment of the present invention is an optical device for splitting an incident beam of light into a reflected beam and a transmitted beam and selectively transmitting only a narrow bandwidth of that transmitted beam. A splitter interface means is provided for splitting the incident beam into the reflected beam and the transmitted beam. A front-cavity interface means is provided for receiving the transmitted beam from the splitter interface means and directing it onward at a normal angle. A rear-cavity interface means is provided for receiving the transmitted beam from the front-cavity interface means at a normal angle. The front-cavity interface means and the rear-cavity interface means are fixedly spaced apart and are partially reflective to the transmitted beam, to define an optical cavity in the manner of a Fabry-Perot interferometer. This thereby provides both integrated beam splitting and etalon functionality in the device.

An advantage of the present invention is that it is inherently economical. It eliminates the use of excessive discrete optical components, substantially reducing material and labor costs as well as reducing manufacturing scrapage and rework.

Another advantage of the invention is that it occupies less space, permitting smaller final assemblies or freeing up space for additional functions or channels.

Another advantage of the invention is that it may be employed in a multi-channel manner with multiple incident beams at once.

And another advantage of the invention is that its lower component count reduces the need for maintenance and increases its reliability, making it highly suitable for use in harsh or remote environments where repair may be difficult or even impossible.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

The purposes and advantages of the present invention will be apparent from the following detailed description in conjunction with the appended figures of drawings in which:

FIG. 1 (background art) is a schematic diagram in perspective view depicting a typical single-channel prior art frequency locker construction.

FIG. 2 (background art) is a schematic diagram in perspective view depicting a typical multi-channel prior art frequency locker construction.

FIG. 3 is a schematic diagram in perspective view depicting one embodiment of the inventive integrated optical device in use.

FIG. 4 is a schematic diagram in perspective view depicting an alternate embodiment of the invention device in use.

FIG. 5 is a schematic diagram in perspective view depicting an embodiment of the invention that has two etalon spacers oriented like those of FIG. 3 and a beam splitting capability like that of FIG. 4.

FIG. 6 is a schematic diagram in perspective view depicting an alternate embodiment of the invention that will direct a reflected beam at a different angle than the embodiment of FIG. 5.

FIGS. 7A-B are schematic diagrams in perspective view depicting embodiments of the invention that each employ two etalon spacers arranged horizontally rather than vertically.

FIGS. 8A-B are schematic diagrams in perspective view depicting embodiments of the invention that employ only a single etalon spacer.

FIGS. 9A-B are schematic diagrams in perspective view depicting embodiments of the invention that take the sprit of integration further and have two separated beam splitters.

FIGS. 10A-B are schematic diagrams in perspective view depicting two possible embodiments of the invention that have two adjacent beam splitters.

FIGS. 11A-B are schematic diagrams in perspective view depicting embodiments of the invention that have solid type Fabry-Perot etalons and no etalon spacers.

FIG. 12 is a collection of schematic diagrams depicting a variety of possible embodiments of the invention and the common principles they employ.

FIGS. 13A-C are a top schematic, side, and perspective views of a solid etalon embodiment of the invention about to be offered commercially.

FIGS. 14A-C are a top schematic, side, and perspective views of an air-spaced etalon embodiment of the invention about to be offered commercially.

And FIG. 15 is a flow chart of a method according to the present invention.

In the various figures of the drawings, like references are used to denote like or similar elements or steps.

### DETAILED DESCRIPTION

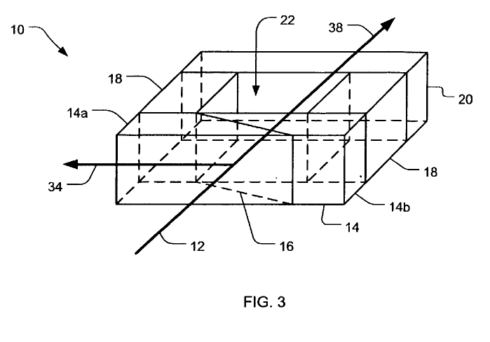

A preferred embodiment of the present invention is an integrated, or hybrid-optical, etalon-beam splitter. As illustrated in the various drawings herein, and particularly in the view of FIG. 3, embodiments of the invention are depicted by the general reference character 10.

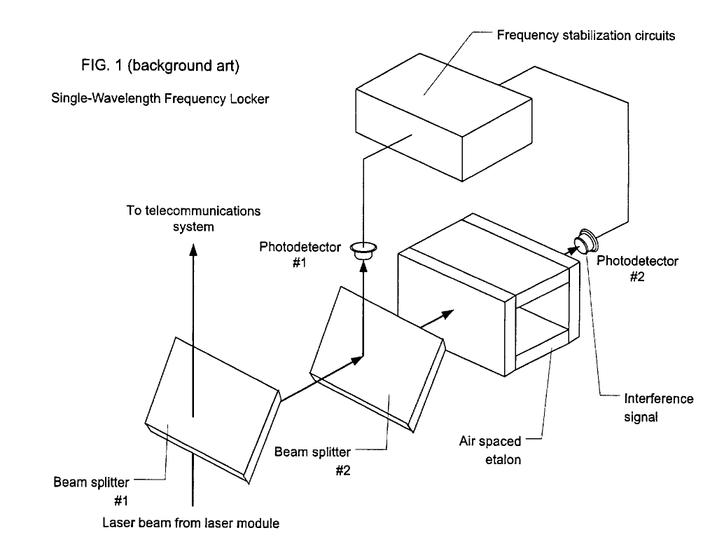

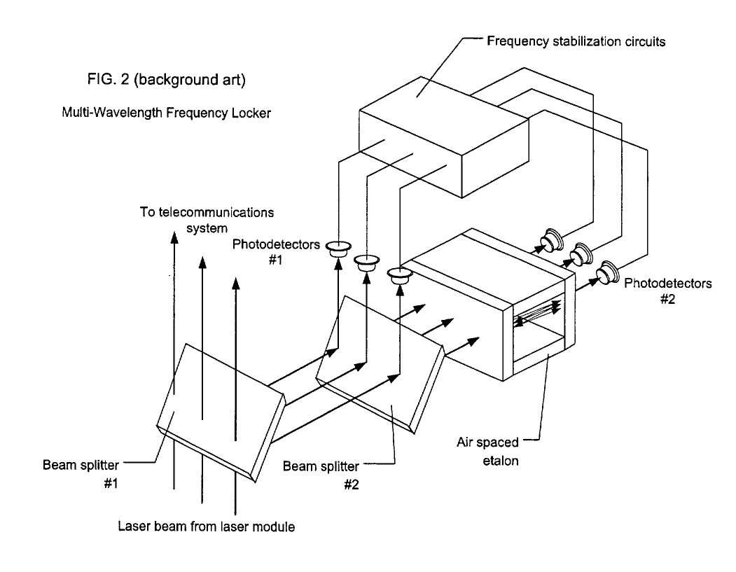

We hereby propose a new integrated optical device 10 which combines a beam-splitting function with an etalon function. FIG. 3 is a schematic diagram depicting an embodiment of the inventive integrated optical device 10 in use with an incident beam 12, for instance, the sample beam of FIGS. 1-2 (background art). The frequency locker examples of FIGS. 1-2 are used in the following discussion, but it should be firmly appreciated that the scope of the present invention extends beyond merely this one telecommunications application.

In the embodiment shown in FIG. 3 the integrated optical device 10 structurally includes a beam splitter 14 formed of two wedges 14a-b with a coating at a splitter interface 16. The rear-most wedge 14b acts as an etalon front plate and directly adjoins two etalon spacers 18 which, in turn, adjoin an etalon back plate 20 to collectively define an etalon region 22. The integrated optical device 10 thus has structure to perform the functions of both a beam splitter and a Fabry-Perot etalon.

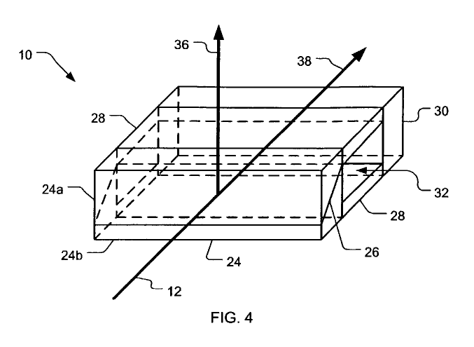

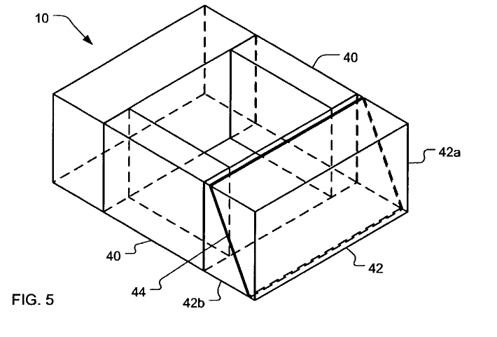

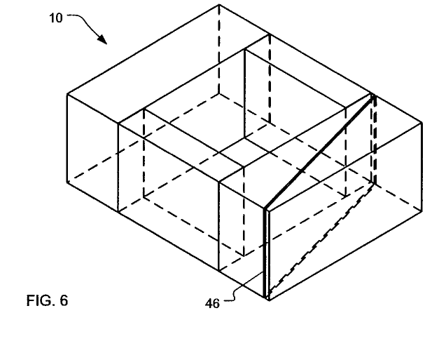

FIG. 4 is a schematic diagram depicting an alternate embodiment of the inventive integrated optical device 10 in use with the incident beam 12. Here the integrated optical device 10 structurally includes a different beam splitter 24 formed of two wedges 24a-b with a coating at a splitter interface 26. The rear-most wedge 24b acts as an etalon front plate and adjoins two etalon spacers 28 which, in turn, adjoin an etalon back plate 30 to collectively define an etalon region 32.

In use, the incident beam 12 enters the beam splitter 14, 24 and at the splitter interface 16, 26 is separated into a reflected beam 34, 36 and a transmitted beam 38. The percentage of the reflected beam 34, 36 split out in this manner can typically range from 50% to 95%, depending on the coating used. The coating may be a conventional partially reflective one or it may be a polarizing coating, such as are commonly used in current beam splitter. All of this is, of course, a matter of mere design preference and may be varied as needed for the particular application requirement. The reflected beam 34, 36 may be used, for instance, in a manner analogous to the reference components in FIGS. 1-2 to monitor intensity in a frequency locker application.

The transmitted beam 38 enters the etalon region 22, 32 and exists the integrated optical device 10 through the etalon back plate 20, 30. In the process, however, interference is produced in the transmitted beam 38. The transmitted beam 38 may also be used in analogous manner to the measurement components in FIGS. 1-2.

The transmitted beam 38 will have a sinusoidal varying intensity that is wavelength dependent. When locking the frequency of the incident beam 12 for telecommunications use, for example, a desirable situation may be to have the intensity of the transmitted beam 38 at 50% of the maximum when exactly on the ITU grid.

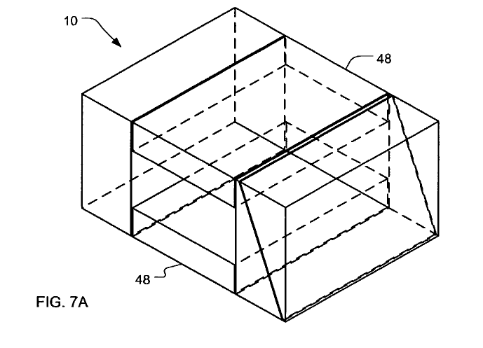

FIG. 5 is a schematic diagram depicting an embodiment of the integrated optical device 10 that has two etalon spacers 40 oriented like those of FIG. 3. A beam splitter 42 here has two wedges 42a-b and a splitter interface 44. In principal, this embodiment in FIG. 5 works equivalently to the embodiments of FIGS. 3-4. Comparing FIGS. 3-5 it can be seen, however, that the orientation of the splitter interface will determine the direction of the reflected beams. It should be noted that the wedges in these embodiments also do not have true triangular cross sections, and are instead slightly trapezoidal. Triangular cross section wedges are usable, but optionally making them slightly trapezoidal facilitates beam splitter assembly and reduces the likelihood of damage in handling during manufacture. With reference again to FIGS. 3-4, the trapezoidal arrangements there are non-optimal for some situations. Having the splitter interface end unsupported at the etalon region, as shown for these embodiments, can result in a less robust overall structure than, say, that of FIG. 5.

FIG. 6 is a schematic diagram depicting an alternate embodiment that will direct a reflected beam at an angel 90 degrees different than the embodiment of FIG. 5, due to the different orientation of a splitter interface 46 here. This embodiment in FIG. 6, however, again depicts a slightly trapezoidal wedge design and a splitter interface orientation that is robust like the embodiment of FIG. 5.

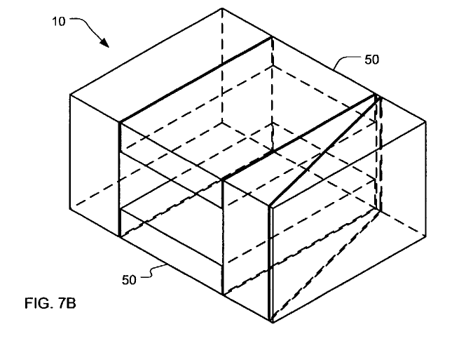

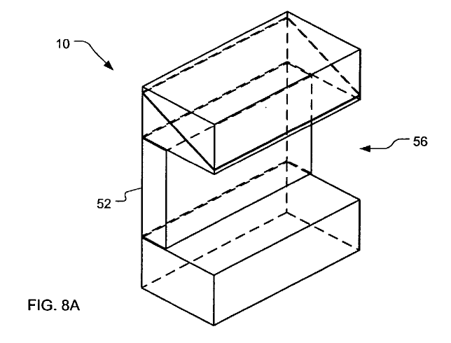

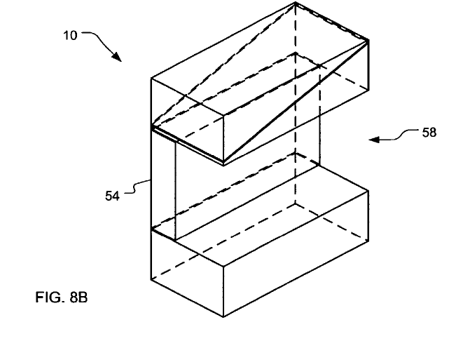

FIGS. 7A-B are schematic diagrams depicting embodiments of the integrated optical device 10 that each employ two etalon spacers 48, 50, but that are arranged horizontally rather than vertically, as is the case in FIGS. 5-6.

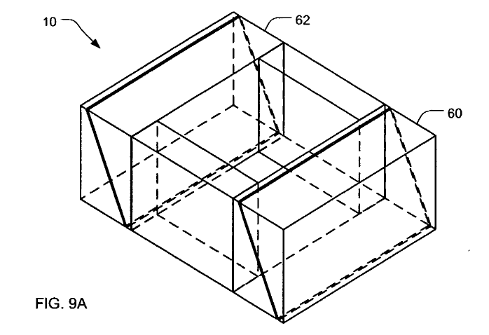

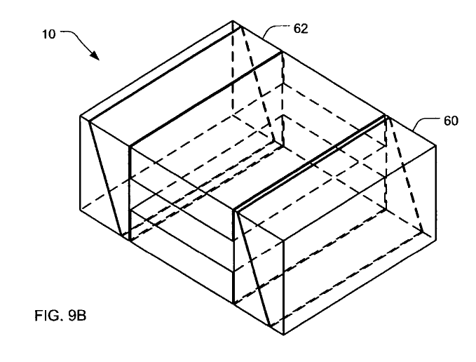

FIGS. 8A-B are schematic diagrams depicting embodiments of the integrated optical device 10 that each employ only a single etalon spacer 52, 54. The etalon regions 56, 58 defined in this arrangement are particularly suitable for use where gas or vacuum fill is used. For example, the entire integrated optical device 10 here may be open in an air environment, or enclosed within an evacuated or nitrogen filled housing. [For ease in discussion, any type of gas or vacuum filled region is informally referred to herein as “air” filled. The etalon regions 56, 58 of FIGS. 8A-B thus are “air-spaced” even if nitrogen fill is used. Other regions of the invention may also employ gas or vacuum fill, as is discussed presently, and these are also informally referred to as being “air” filled.] If more beam splitting functionality is required, one or more beam splitters and etalons can be attached together by optic contact to maximize the function. The following figures present just a few of the possible options here.

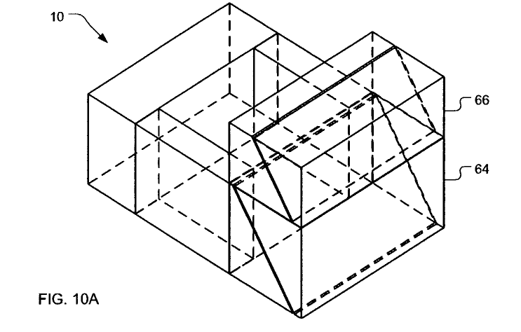

FIGS. 9A-B are schematic diagrams depicting embodiments of the integrated optical device 10 that take the spirit of integration further by having two separated beam splitters 60, 62. The first beam splitter 60 functions as a front etalon plate and the second beam splitter 62 functions as a rear etalon plate.

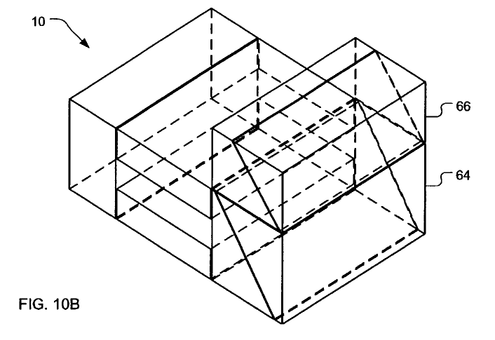

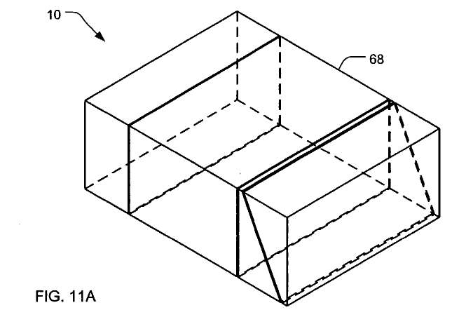

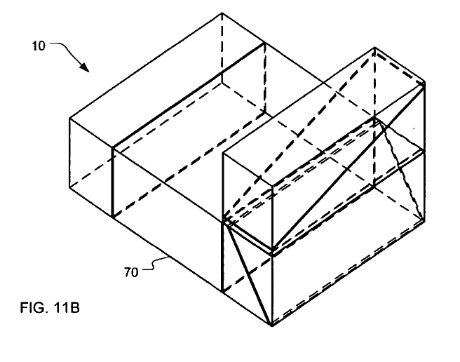

FIGS. 10A-B are schematic diagrams depicting embodiments of the integrated optical device 10 that each have two adjacent beam splitters 64, 66. A number of variations on this theme are possible. Rather than have two adjacent beam splitters stacked vertically, as shown, two can be abutted horizontally. The benefits of variations like this can be seen with reference again to FIGS. 1-2, where such an embodiment of the present invention would be able to replace all of the discrete optical elements otherwise needed. Another variation of adjacent splitters may use splitter surfaces that are not parallel like those shown in FIGS. 10A-B, see e.g., FIG. 11B.

FIGS. 11A-B are schematic diagrams depicting embodiments of the integrated optical device 10 that have no etalon spacers. Rather, an etalon region 68, 70 here is filed with a solid substance to form a solid Fabry-Perot etalon.

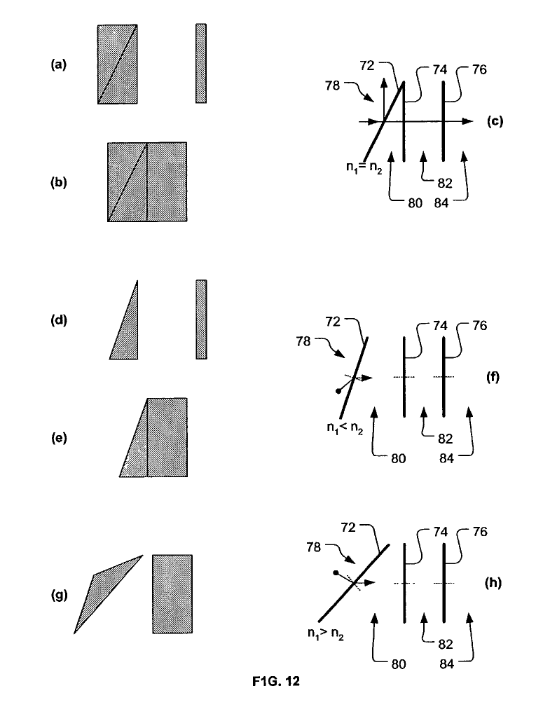

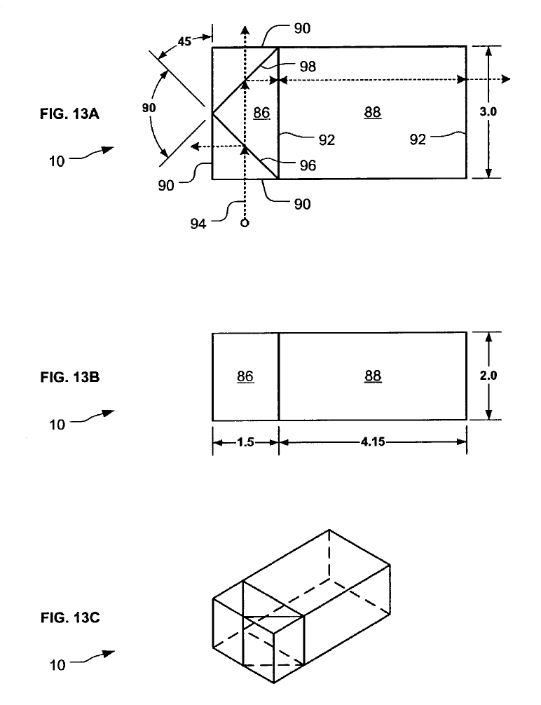

FIG. 12 is a collection of schematic diagrams depicting a variety of possible embodiments of the invention and the common principles they employ. FIGS. 12(a) and (b) are cross-sectional views of air-spaced and solid etalon embodiments using two-piece beam splitters, while FIG. 12(c) is a stylized depiction of the principles at work here. Three interfaces, a splitter interface 72, a front-cavity interface 74, and a rear-cavity interface 76 are present. These separate four regions 78, 80, 82, 84. Proceeding from left to right, the third region 82 in FIGS. 12(a) and (d) is of air, gas, or vacuum. Similarly, the fourth region 84 in FIGS. 12(b) and (e) is of air, gas, or vacuum. [The three interfaces referred to here are the principal interfaces of the invention, as will become apparent as FIG. 12 is discussed in its entirety. Additional, interfaces and regions defined by them are, of course, also possible. For example, FIG. 11B has one additional interface and an additional region in its second beam splitter. The embodiment in FIG. 12(a) also has trivial interfaces at the left-most edge of the beam splitter and at the right-most edge of the etalon back plate. Such additional interfaces and regions, however, are not germane to this discussion of FIG. 12.] FIGS. 12(d) and (e) represent the further use of “open” regions. These are cross-sectional views of air-spaced and solid etalon embodiments using single-piece beam splitters, and FIG. 12 (f) is a stylized depiction of the principles at work here. Again, the three interfaces are present and they separate the four regions. The first region 78 here is of air, gas, or vacuum (generically, “air”).

FIG. 12(g) is a cross-sectional view of yet another embodiment of the invention, and FIG. 12(h) is a stylized depiction of its principles. Again, three interfaces are present and again they separate the four regions. The second region 80 and the fourth region 84 here are “air” filled.

In FIGS. 12(a) and (b) the two-pieces of the beam splitters are noted as having the same indices of refraction (n₁=n₂). This is a conventional design for a beam splitter, wherein a partially reflective coating is provided at the separating splitter interface 72. Various coating schemes are known and may be used to obtain partially reflectivity, including polarization. The invention may use one or a combination of these.

Other means than coating may also be employed by the separating splitter interface 72. For example, a material with birefringence characteristics can act as a beam splitter. Alternately, differing indices of refraction (n₁<>n₂) may be used. FIGS. 12(d), (e), and (g) depict three such embodiments. Those depicted embodiments use air-solid and solid-air materials, but those skilled in the optical arts will readily appreciate that solid-solid (n₁<n₂ or n₁>n₂) are also possible. This emphasizes a key point: the scope of the invention is not limited to any particular structure or set of structures. Rather, the invention is the use of (only) the three interfaces 72, 74, 76 to produce its particular benefits. Again, these are the splitter interface 72 (at least one, more may be added if desired) and the front-cavity interface 74 and the rear-cavity interface 76 of the etalon.

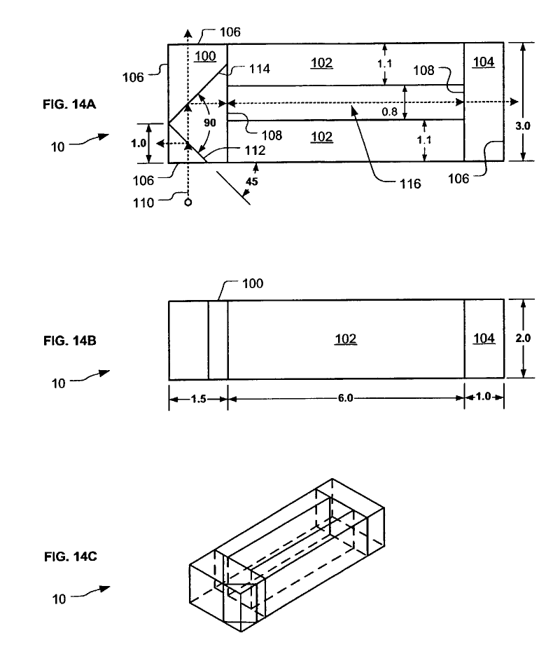

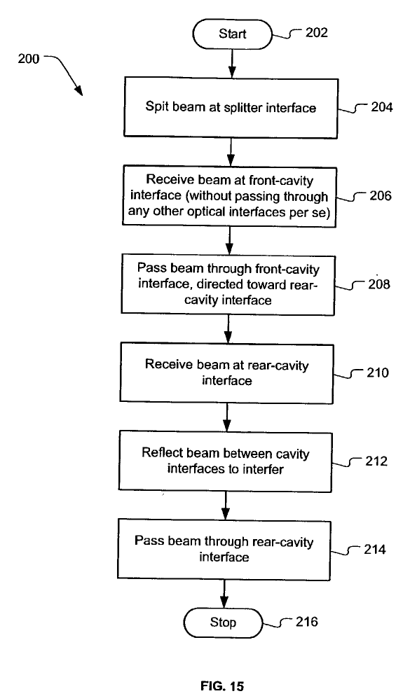

FIGS. 13A-C and FIGS. 14A-C depict embodiments of the integrated optical device 10 that are about to be offered commercially. The dimensions here are in millimeters and degrees and, as those skilled in the art will appreciate, these embodiments of the invention may easily be integrated into larger electro-optical assemblies. For example, they may be used as the working portion of discrete components or they may be effectively used as integral components of modular assemblies.

FIG. 13A is a top schematic view, FIG. 13B is a side view, and FIG. 13C is a perspective view of an embodiment of the integrated optical device 10. A beam-splitter section 86 is mated (optically contacted) to a solid etalon section 88. In this embodiment, the inventors use silica as the material for these components. The beam-splitter section 86 has three external end surfaces 90 in the optical path, and these are provided with an anti-reflective coating suitable for an 1550 nm. The etalon section 88 is designed for a free spectral range (FSR) of 25 GHz at a 1550 nm wavelength. Its end surfaces 92 in the optical path are coated to have 30% reflectivity, and to have a high degree of surface flatness.

In use, a light beam 94 is directed into the beam-splitter section 86 as shown, where it encounters a first splitter interface 96, having a 10% reflectivity, and a second splitter interface 98, having a 30% reflectivity. At the first splitter interface 96 a first portion of the light beam 94 is redirected out of the integrated optical device 10. In application, this portion may be directed into a sensor and used to obtain a “raw” intensity measurement, i.e., one representing all of the light frequencies present. Similarly, at the second splitter interface 98 a second portion of the light beam 94 is redirected but here further into the integrated optical device 10. Specifically, it enters the etalon section 88 and ultimately exits from it having a very narrow frequency bandwidth. This portion of the light beam 94 may be directed into a sensor and used to obtain a frequency-specific intensity measurement. A third portion of the light beam 94 is not redirected, and instead passes directly through the beam-splitter section 86. In application, this portion may used for carrying modulated information present in the light beam 94 onward to another system.

FIG. 14A is a top schematic view, FIG. 14B is a side view, and FIG. 14C is a perspective view of another embodiment of the integrated optical device 10 designed for a FSR=25 GHz at a 1550 nm wavelength. A beam-splitter section 100 is mated to two etalon spacers 102, which in turn are mated to an etalon back plate 104. In this embodiment the inventors use fused silica for the beam-splitter section 100 and the etalon back plate 104, and an ultra low thermal expansion (ULE) type material for the etalon spacers 102. The beam-splitter section 100 and the etalon back plate 104 have external end surfaces 106 in the optical path, and these are provided with an anti-reflective coating suitable for an 1550 nm wavelength. The beam-splitter section 100 and the etalon back plate 104 have internal end surfaces 108 in the optical path. These are coated to have 30% reflectivity, and to have a high degree of surface flatness.

In use, a light beam 110 is directed into the beam-splitter section 100 as shown, where it encounters a first splitter interface 112, having a 10% reflectivity, and a second splitter interface 114, having a 30% reflectivity. At the first splitter interface 112 a first portion of the light beam 110 is redirected out of the integrated optical device 10. Similarly, at the second splitter interface 114 a second portion of the light beam 110 is redirected further into the integrated optical device 10. Specifically, it enters an air-space etalon cavity 116 and ultimately exists from that having a very narrow frequency bandwidth. Finally, a third portion of the light beam 110 is not redirected, and instead passes directly through the beam-splitter section 100.

FIG. 15 is a flow chart of a method 200 the present invention may employ. The method 200 starts in a step 202. Next, in a step 204 an incident beam (e.g., incident beam 12) is split at a splitter interface (e.g., splitter interface 72) into a reflected beam (e.g., reflected beam 34, 36) and a transmitted beam (e.g., transmitted beam 38).

In a step 206 the transmitted beam is received at a front-cavity interface (e.g., front-cavity interface 74). A key point to again note here is that the transmitted beam travels from the splitter interface to the front-cavity interface without passing through any intervening other optical interfaces. That is, the region between the splitter interface and the front-cavity interface is “filled” with only one material (vacuum, gas, or solid). [An anti-reflective coating may, however, be used at the front-cavity interface.] Proceeding, in a step 208 the transmitted beam is passed through the front-cavity interface, directed toward a rear-cavity interface (e.g., rear-cavity interface 76). And in a step 210 the transmitted beam arrives at the rear-cavity interface.

In a step 212 the transmitted beam is reflected back and forth between the two cavity interfaces a number of times. In actual practice, of course, the interfaces are only partially reflective, but a substantial portion of the transmitted beam may be retained within the etalon cavity. Furthermore, in the characteristic manner of the Fabry-Perot etalon, interference occurs in the transmitted beam. Light wavelengths within the free spectral range (FSR) of the etalon reinforce and remain present in the transmitted beam.

In a step 214 the transmitted beam passes through the rear-cavity interface, exiting the etalon. The transmitted beam now has a very narrow range of wavelengths present.

In a step 216 this method 200 of splitting an incident beam of light into a reflected beam and a transmitted beam and selectively transmitting only a narrow bandwidth of the transmitted beam is finished. The initial and final steps 202, 216 may include no formal action, or they may include set-up and wrap-up processes as desired for specific applications, or they may include additional beam splitting operations. For example, the incident beam may be split into multiple portions before reaching and being split at the splitter interface. The reflected beam may also be split into multiple portions after being split off at the splitter interface. And the transmitted beam may be split into multiple portions after passing the rear-cavity interface.

Finally, with reference again to FIG. 2 (background art), it should be appreciated that the inventive integrated optical device 10 can be provided in suitable size to accommodate multiple laser channels concurrently, with the attendant multi-channel benefits following from that.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

Industrial Applicability

The present integrated optical device 10, and its associated method 200, are well suited for application in splitting incident beams of light into reflected beams and transmitted beams having only narrow light bandwidths. The invention employs a simple, but sophisticated component configuration that provides a number of advantages over the prior art.

Embodiments of the invention may occupy less space, permitting smaller final assemblies or freeing up space for additional functions or channels. The invention may be, indeed, be employed in a multi-channel manner with multiple incident beams at once.

The invention is also inherently economical. It eliminates the use of excessive discrete optical components. As each component is individually fabricated, installed, and adjusted, this substantially reduces material and labor costs. Similarly, scrapage and rework is reduced, due to the elimination of opportunities for error in manufacturing. As noted, the invention may also be embodied in multi-channel form, to leverage its advantages yet further.

The invention also may provide particular benefits after its initial manufacture. Its lower component count lowers the need for maintenance and increases its reliability. These benefits, of course, extend to larger assemblies using the invention. Many frequency locker applications today are in harsh or even remote environments. In some cases repair is essentially impossible. With component service or replacement highly undesirable, difficult, or even impossible, the invention fills needs that the prior art simply cannot.

With these advantages, the present invention fills substantial and growing current needs in industry. Telecommunications is one particular example, but those skilled in the art can will readily appreciate the present invention's advantages for other fields as well. Examples of how the invention may be employed, without limitation, include compact fiber-optics modules for use in frequency lockers, interleavers, etc. It may also be used with single and multi-wavelength discrete laser modules; and with single and multi-wavelength integrated laser modules.

For the above, and other, reasons, it is expected that the present invention will have widespread industrial applicability and it is therefore expected that the commercial utility of the present invention will be extensive and long lasting.

1. An optical device for splitting an incident beam of light into a reflected beam and a transmitted beam and selectively transmitting only a narrow bandwidth of the transmitted beam, the device comprising:
a splitter interface adjoining a first region and a second region, wherein said splitter interface is suitable for splitting the incident beam into the reflected beam and the transmitted beam;
a front-cavity interface adjoining said second region and a third region;
a rear-cavity interface adjoining said third region and a fourth region;
said front-cavity interface being oriented to receive the transmitted beam from said splitter interface and direct the transmitted beam onward toward said rear-cavity interface at a normal angle; and
said front-cavity interface and said rear-cavity interface being fixedly spaced apart by said third region, being plainerly parallel, and both being partially reflective, thereby defining an optical cavity of a Fabry-Perot interferometer and providing both beam splitting and etalon functionality in the device.

2. The device of claim 1, wherein said splitter interface includes a partially reflective coating to split the incident beam into the reflected beam and the transmitted beam.

3. The device of claim 2, wherein said coating is polarized.

4. The device of claim 1, wherein:
said first region and said second region have differing indices of refraction; and
said splitter interface is oriented to receive the incident beam at a non-normal angle of incidence such that the reflected beam is reflected and the transmitted beam is refracted, thereby splitting the incident beam into the reflected beam and the transmitted beam.

5. The device of claim 1, wherein said front-cavity interface includes an anti-reflective coating to facilitate the transmitted beam passing through said front-cavity interface and thus from said second region and into said third region.

6. The device of claim 1, wherein at least one of said front-cavity interface and said rear-cavity interface include a partially reflective coating to facilitate reflecting the transmitted beam within said optical cavity.

7. The device of claim 1, wherein said second region and said third region have differing indices of refraction to facilitate reflecting the transmitted beam within said optical cavity.

8. The device of claim 1, wherein said third region and said fourth region have differing indices of refraction to facilitate reflecting the transmitted beam within said optical cavity.

9. The device of claim 1, wherein said first region is of a gas material or vacuum and said second region is of a solid material.

10. The device of claim 9, wherein said second region includes an optical wedge.

11. The device of claim 1, wherein said first region and second region are both of solid materials.

12. The device of claim 11, wherein said first region and said second region each include optical wedges.

13. The device of claim 1, wherein said second region is of a gas material or vacuum and said third region is of a solid material, thereby having said optical cavity in a solid type etalon.

14. The device of claim 1, wherein said second region and third region are both of solid materials, thereby having said optical cavity in a solid type etalon.

15. The device of claim 1, wherein said third region is of a gas material or vacuum and said fourth region is of a solid material, thereby having said optical cavity in an air-spaced type etalon.

16. The device of claim 15, further comprising at least one spacer that fixedly spaces apart said front-cavity interface and said rear-cavity interface.

17. The device of claim 1, wherein said third region and fourth region are both of solid materials, thereby having said optical cavity in a solid type etalon.

18. The device of claim 1, wherein said splitter interface is a first splitter interface and the device further comprising at least one second splitter interface.

19. The device of claim 18, wherein a said second splitter interface is in the optical path of the incident beam ahead of said first splitter interface, thereby facilitating splitting out a portion of the incident beam before it is split into the reflected beam and the transmitted beam.

20. The device of claim 18, wherein a said second splitter interface is in the optical path of the reflected beam, thereby facilitating splitting the reflected beam into multiple portions.

21. The device of claim 18, wherein a said second splitter interface is in the optical path of the transmitted beam after said optical cavity, thereby facilitating splitting the transmitted beam into multiple portions.

22. An optical device for splitting an incident beam of light into a reflected beam and a transmitted beam and selectively transmitting only a narrow bandwidth of the transmitted beam, the device comprising:
splitter interface means for splitting the incident beam into the reflected beam and the transmitted beam;
front-cavity interface means for receiving the transmitted beam from said splitter interface means and passing the transmitted beam there through, wherein no intervening optical interfaces separate said front-cavity interface means from said splitter interface means;
rear-cavity interface means for receiving the transmitted beam from said front-cavity interface means, wherein said front-cavity interface means and said rear-cavity interface means are plainerly parallel and fixedly spaced apart;
said front-cavity interface means and said rear-cavity interface means both further for redirecting the transmitted beam there between a plurality of times; and
said rear-cavity interface means further for ultimately passing the transmitted beam there through, thereby providing beam splitting and etalon functionality in an integrated manner.

23. The device of claim 22, wherein said splitter interface means includes partially reflective means for splitting the incident beam into the reflected beam and the transmitted beam.

24. The device of claim 22, wherein:
said splitter interface means includes a junction of two differing indices of refraction; and
said splitter interface means is oriented to receive the incident beam at a non-normal angle of incidence such that the reflected beam is reflected and the transmitted beam is refracted at said junction.

25. The device of claim 22, wherein at least one of said front-cavity interface means and said rear-cavity interface means include a partially reflective coating to facilitate reflecting the transmitted beam within said optical cavity.

26. The device of claim 22, wherein at least one of said front-cavity interface means and said rear-cavity interface means include a junction of two differing indices of refraction to facilitate reflecting the transmitted beam within said optical cavity.

27. The device of claim 22, wherein said splitter interface means is at a junction of a gas material or vacuum and a solid material.

28. The device of claim 22, wherein said splitter interface means is at a junction of two solid materials.

29. The device of claim 22, wherein said front-cavity interface means is at a junction of a gas material or vacuum and a solid material.

30. The device of claim 22, wherein said front-cavity interface means is at a junction of two solid materials, thereby having said optical cavity in a solid type etalon.

31. The device of claim 22, wherein said rear-cavity interface means is at a junction of a gas material or vacuum in said optical cavity and a solid material, thereby having said optical cavity in an air-spaced type etalon.

32. The device of claim 31, further comprising at least one spacer means for fixedly spacing apart said front-cavity interface means and said rear-cavity interface means.

33. The device of claim 22, wherein said rear-cavity interface means is at a junction of two solid materials, thereby having said optical cavity in a solid type etalon.

34. A method for splitting an incident beam of light into a reflected beam and a transmitted beam and selectively transmitting only a narrow bandwidth of the transmitted beam, the method comprising the steps of:
(a) splitting the incident beam into the reflected beam and the transmitted beam at a splitter interface;
(b) receiving the transmitted beam at a front-cavity interface from said splitter interface, wherein no intervening optical interfaces separate said splitter interface and said front-cavity interface;
(c) passing the transmitted beam through said front-cavity interface and directing the transmitted beam toward a rear-cavity interface at a normal angle;
(d) receiving the transmitted beam at said rear-cavity interface, wherein said front-cavity interface and said rear-cavity interface are plainerly parallel and fixedly spaced apart;
(e) reflecting the transmitted beam between said front-cavity interface and said rear-cavity interface a plurality of times; and
(f) passing the transmitted beam through said rear-cavity interface, thereby providing both integrated beam splitting and etalon functionality.

35. The method of claim 34, wherein said step (a) includes reflecting the reflected beam and passing the transmitted beam at a partially reflective coating at said splitter interface.

36. The method of claim 34, wherein:
said splitter interface includes a junction of two differing indices of refraction; and
said step (a) includes orienting said splitter interface to receive the incident beam at a non-normal angle of incidence such that the reflected beam is reflected and the transmitted beam is refracted at said junction.

37. The method of claim 34, wherein said step (e) includes partially reflecting the transmitted beam within said optical cavity at a partially reflective coating at said front-cavity interface.

38. The method of claim 34, wherein:
said front-cavity interface includes a junction of two differing indices of refraction; and
said step (e) includes partially reflecting the transmitted beam at said junction.

39. The method of claim 34, wherein said step (e) includes partially reflecting the transmitted beam within said optical cavity at a partially reflective coating at said rear-cavity interface.

40. The method of claim 34, wherein:
said rear-cavity interface includes a junction of two differing indices of refraction; and
said step (e) includes partially reflecting the transmitted beam at said junction.

41. The method of claim 34, wherein a plurality of the incident beams are provided and said steps (a)-(f) are concurrently performed on said plurality of the incident beams to provide respective pluralities of the reflected beams and the transmitted beams.
